(19) United States
(12) Patent Application Publication
(10) Pub. No.: US 2012/0265578 A1
(43) Pub. Date: Oct. 18, 2012

(54) COMPLETING TASKS INVOLVING CONFIDENTIAL INFORMATION BY DISTRIBUTED PEOPLE IN AN UNSECURE ENVIRONMENT

(75) Inventors: Benjamin P. Olding, San Francisco, CA (US); Nathan Norfleet Eagle, Boston, MA (US); Martin A. Quiroga, San Francisco, CA (US)

(73) Assignee: JANA MOBILE, INC., San Francisco, CA (US)

(21) Appl. No.: 13/445,787

(22) Filed: Apr. 12, 2012

Related U.S. Application Data
(60) Provisional application No. 61/474,274, filed on Apr. 12, 2011.

(51) Int. Cl. G06Q 10/06

(52) U.S. Cl. 705/7.25

(57) ABSTRACT

A system receives from a client a job comprising confidential information. The system then distorts the confidential information associated with the job. Next, the system divides the job into multiple discrete tasks such that the distorted confidential information is further divided and the confidential information cannot be deciphered from an individual task. The tasks are then delegated to respondents in different geographical locations with different social preferences. Because of these differences the respondents are unlikely to communicate information about their job with each other. The respondents receive the job securely through their electronic devices, perform the delegated tasks, and provide the system with responses to the tasks through the devices. The system receives the responses for individual tasks, deduces a unified job response from the received responses and transmits the unified response to the client.

### CROSS-REFERENCE TO RELATED APPLICATION

This application claims the benefit of U.S. Provisional Application No. 61/474,274, filed Apr. 12, 2011, which is hereby incorporated by reference in its entirety.

### BACKGROUND

This invention relates generally to managing a group of people distributed over electronic communication networks, and more particularly to completing tasks that involve confidential information using respondents in a distributed group of people in an unsecure environment.

Many processes that an organization, such as a business, need to perform can be divided into a number of discrete tasks that must be performed manually. For example, a business may need a human to review and classify a large number of pictures, as this process may not be feasible to perform using a machine. To classify each picture, in this example, a human may use a computer system to access and view each graphical image, determine how to classify the image, and then enter the classification into the computer system. The tasks that are required to complete a process may be performed by a single person, who may be an employee of the organization. Alternatively, since the tasks can be discrete, the tasks may be distributed to and performed by a number of different people, and the results of the tasks later combined to complete the process.

In many cases, the local labor that is available to an organization may not always be appropriate for the tasks, depending on the job that the organization needs to be performed. In a wealthy industrialized country, for example, the local group of people may not be willing to perform relatively small tasks for a relatively small reward, whereas respondents from other areas in the world might be willing to do the tasks for the compensation that the organization is willing to pay. The proliferation of electronic communication networks, such as the Internet and cellular networks, has increased the availability of respondents who are located remote from the businesses and organizations that could benefit from their labor. Nevertheless, sending tasks to a distributed group of people still presents many logistical issues.

The use of a large group people to perform multiple discrete tasks is often referred to as “crowdsourcing.” Existing crowdsourcing systems typically provide tasks to any anonymous person willing to perform them, so that the crowdsourcing systems have little or no knowledge of the capabilities of these persons. As a result, these systems fail to motivate people to perform tasks well and thus fail to achieve a high quality of results from the contributors. Existing crowdsourcing systems also do not leverage relationships or commonalities that may exist among the people performing tasks. Additionally, secure jobs including confidential information cannot be safely distributed through crowdsourcing. These and other limitations of crowdsourcing have rendered it inappropriate for solving the needs of many organizations that have tasks that must be performed reliably and economically.

### SUMMARY

To allow an organization to use the labor of respondents who are accessible via communication networks, embodiments of the invention provides mechanisms to manage respondents in an unsecure environment to process confidential data securely. In one embodiment, a system maintains respondent profiles for a number of respondents who have registered with the system. When the system receives a new job that includes confidential information, the system may distort the confidential information to keep it secure. For example, if a job involves processing digital photographs of people, the system may reduce the resolution of the images so that the faces of the people are not readily discernable. Additionally or alternatively, the system may divide the job into discrete tasks so that the confidential information cannot be deciphered from the individual tasks. For example, if a job involves processing a document that contains a social security number, the system may divide the document into three parts wherein the social security number in the document is itself divided into three different parts.

In another embodiment, the job involves gathering confidential data like gathering information about a store and about the prices of products sold in the store. Such data gathering jobs are divided into different tasks such that individual tasks assigned to respondents do not provide adequate information to the respondents to infer the value, purpose or confidential nature of the data being gathered. A job for gathering data for a store may therefore be divided into tasks for gathering data about the store and tasks gathering data about the product prices in the store. Moreover, tasks from multiple jobs may be combined with each other to further prevent the respondents from inferring the value of data being gathered through the tasks. The tasks for gathering information about a store may be combined with tasks for gathering information about other stores, and the tasks for gathering pricing information for a store may be combined with tasks for gathering pricing information for products in other stores. Such division of jobs into tasks and combination of tasks from multiple jobs prevents a respondent from determining the value, purpose or confidential nature of the data being gathered.

In yet another embodiment, a job involves gathering information through a questionnaire, like gathering information indicating the consumers' opinions about a particular brand. Such a job may be divided into discrete tasks, wherein none of the tasks include a complete questionnaire. Additionally, if the job involves gathering information about consumers' opinions on multiple brands, some of the questions from different questionnaires for different brands may be combined together into different tasks. Such combination of questions from different questionnaires in a task or withholding some of the questions from a questionnaire in a task prevents a respondent from determining the value, purpose or confidential nature of the data being gathered.

In various embodiments in which the system protects confidential information by dividing it among multiple tasks, the system delegates the tasks to the respondents based at least in part on information about the respondents, which may be stored in the respondent profile for each of the respondents, and possibly on information about the tasks. To delegate the tasks to respondents, for example, the system may choose respondents that are unlikely to contact and discuss with each other information associated with their respective tasks. Accordingly, the system may choose respondents separated by geographical location and social preferences. In this way, the respondents are unlikely to retain all the task information, contact each other, combine the information from their task, and then decipher the confidential information.

After delegating tasks to the respondents, the system sends the delegated tasks over a network to electronic devices associated with the respondents. Once the system receives responses for the delegated tasks, the system determines a result based on the received responses and communicates the result to the job provider.

By distorting the confidential information associated with a job and/or dividing the confidential information into various tasks and distributing the information to respondents that are unlikely to communicate with each other, the system ensures that the confidential information related to a job will be secured even when transmitted to a distributed group of people in a relatively unsecured environment. Accordingly, the respondents can perform their part of the secure job (i.e., the task) without learning confidential information that may be associated with the job. The system can thus be used to manage unsecure respondents for completing secure jobs without the risk of leaking confidential information.

### BRIEF DESCRIPTION OF THE DRAWINGS

FIG. 1 illustrates the relationships among various entities in a distributed group of people, in accordance with one embodiment of the invention.

FIG. 2 illustrates a system for managing tasks and respondents in a distributed group of people, in accordance with one embodiment of the invention.

FIG. 3 is a block diagram of the job processor server of FIG. 2, in accordance with one embodiment of the invention.

FIG. 4 is a block diagram of a respondent server of FIG. 2 in accordance with one embodiment of the invention.

FIG. 5 illustrates a process for registering a respondent, in accordance with one embodiment of the invention.

FIGS. 6A and 6B illustrate a process for managing the performance of a job by a distributed group of people, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Management System for a Distributed Group of People

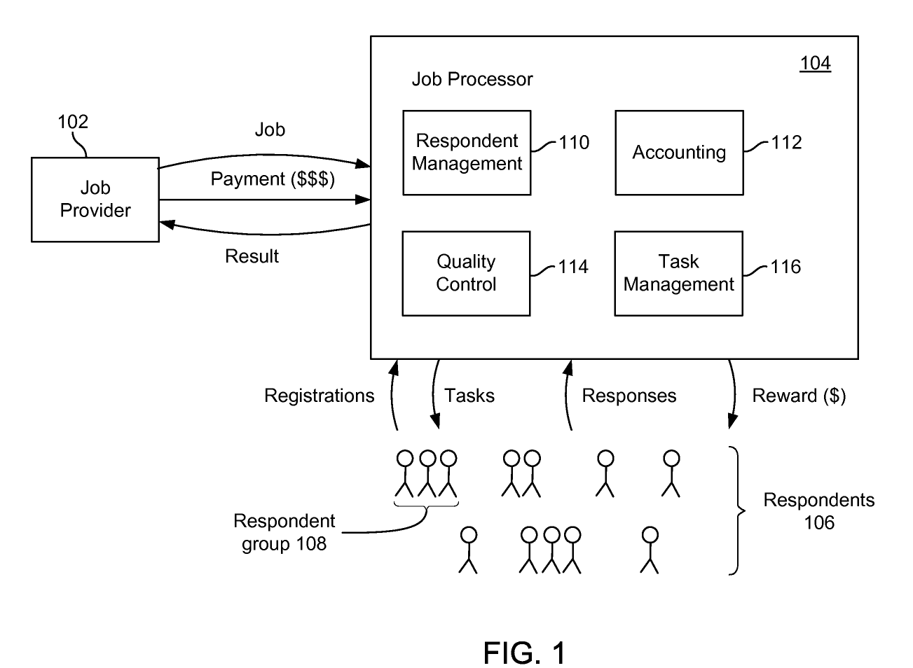

FIG. 1 illustrates the relationships among various entities in one embodiment of a distributed group of people. The distributed group of people can include people, computers, or a combination of people and computers. A job provider 102 sends a job that it desires to have completed to a job processor 104. The job provider 102 may be an individual, organization, business, or any other entity that needs a job to be performed on its behalf. The job processor 104 is an entity that organizes the tasks and their completion on behalf of the job provider 102. The job provider 102 may also submit a payment to the job processor 104 as compensation for performing the job. In one implementation, the job processor 104 is a service provider that offers distributed group of people management services for a number of job providers 102, which are clients of the job processor 104.

The job processor 104 completes jobs for the job provider 102 using respondents 106. The job processor 104 uses a number of systems to carry out its processes, including respondent management 110, quality control 114, accounting 112, and task management 116. After the job provider 102 sends a job to the job processor 104, the job processor 104 divides the job into a number of discrete tasks that can be performed individually and separately. If the job being divided includes sensitive information requiring confidentiality, the job processor 104 divides the sensitive job into multiples tasks such that information in each task alone does not disclose the sensitive information associated with the job. The job processor 104 then delegates the tasks to respondents 106, receives responses (i.e., answers to the delegated tasks) from the respondents 106, and then submits an overall job result to the job provider 102. The job processor 104 keeps track of the individual respondents 106 and has information about the respondents 106 and their past performance of tasks. This information allows the job processor 104 to delegate more appropriate tasks to each respondent 106 and thus to achieve a higher quality result for each of the overall jobs.

Respondents 106 receive tasks from the job processor 104, perform the tasks, and submit responses to the job processor 104. Respondents 106 may also initially register with the job processor 104 to enable the job processor 104 to better track and identify the respondents 106. For clarity, in the description below, respondents 106 are considered to be individual persons. These persons may be marketers, salesperson, consumers or other people associated with a product or a service. In other embodiments, a respondent 106 may comprise a group of people, a corporation, or another entity. In other embodiments, the system may also use automatic algorithms (e.g., image recognition routines) to perform some of the tasks that might otherwise be performed by human respondents. Respondents 106 may be divided into respondent groups 108 that share a common connection or property, as described further below. Respondents 106 may be provided with various types of rewards for completing tasks and submitting responses. The job processor 104 receives the submitted responses and collates information from the responses. The job processor 104 provides the collated information as job results to the job provider 102.

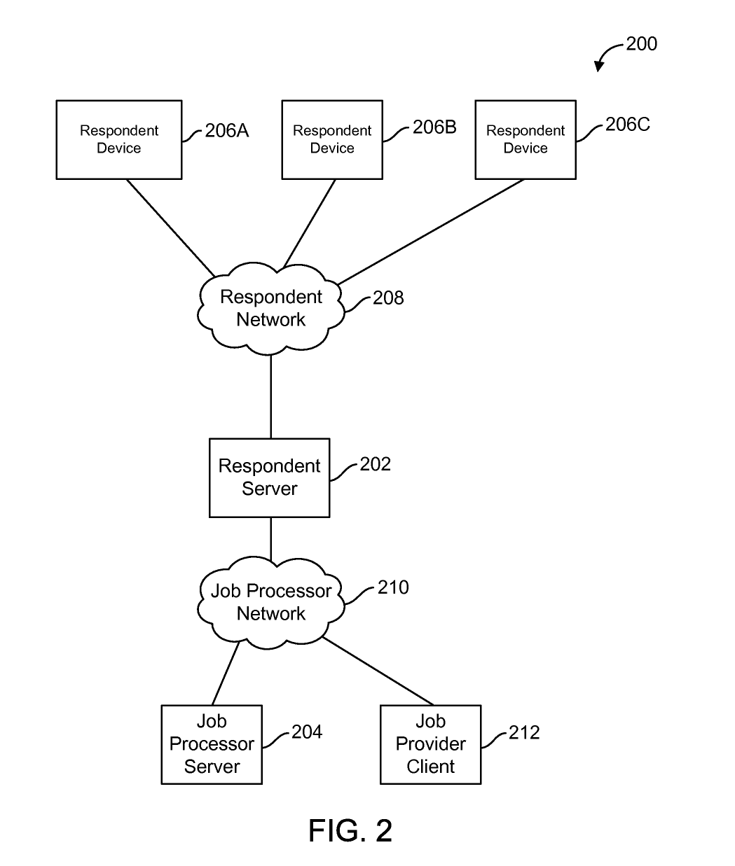

FIG. 2 illustrates a system 200 for managing tasks and respondents 106 in a distributed group of people, in one embodiment. The system 200 includes a job processor server 204, a job provider client 212, a respondent server 202, and respondent devices 206. A job provider 102 interacts with the system through the job provider client 212. The job provider client 212 may be any computing device, such as a workstation or mobile computing device. The job provider may submit jobs, view job status, submit payment, and receive results through the job provider client 212. The job processor server 204 is a computing device that carries out the functions of the job processor 104 described above, including respondent management and task division and delegation. In one embodiment, the job processor server 204 is a server with significant storage and computing capabilities to allow for handling many job providers, respondents, jobs, and tasks.

The respondent devices 206 are computing devices for use by respondents 106 to interact with the system 200. Respondents may use the respondent devices 206 to register with the system, receive tasks, submit responses, and view feedback and rewards, in one embodiment. Respondent devices 206 may be inexpensive mobile devices, such as basic cell phones with text messaging capabilities, which are readily available and widely used in many developing countries. The respondent devices 106 may also include computers in public internet cafes, which the respondents may log into and use from time to time. These are just a few examples, however, and the respondent devices 106 may be any suitable type of device that enables a respondent to communicate with the respondent server 202 to engage in any of the actions described herein in connection with the respondent devices 106.

The respondent server 202 provides an interface for the respondent devices 206 to the job processor server 204. The respondent server 202 may receive registration messages from respondent devices 206 and perform a portion of the processing of the registration messages (e.g., bouncing bad registration requests) before the new respondent is added to the databases of the job processor server 204. The respondent server 202 may receive task delegations in bulk from the job processor server 204 and send the tasks to individual respondent devices 206. The respondent server 202 may similarly receive responses from the respondent devices 206 and send them in bulk to the job processor server 204. In one embodiment, the respondent server 202 handles local communication issues with the respondent devices 206. For example, if a respondent device 206 is a cell phone, the respondent server may communicate via text messages with the cell phone. The job processor server 204 does not need to be aware of the particular communication methods and protocols used between the respondent server 202 and the respondent devices 206.

The job processor server 204, job provider client 212, and respondent server 202 are connected by a job processor network 210. This may be any type of communication network, such as a corporate intranet, a wide area network, or the Internet. The respondent server 202 communicates with the respondent devices 206 through a respondent network 208. This may also be any type of communication network. In one embodiment, the respondent network 208 is a cellular network that supports text messaging, and the respondent devices 206 are cell phones. Although only three respondent devices 206 are shown, there may be many (e.g., hundreds, thousands, or more) in the system 200. Similarly, there may be many respondent servers 202 and job provider clients 212 that communicate with job processor server 204. There may also be multiple job processor servers 204, such as for redundancy or load balancing purposes.

In one embodiment, the respondents 106 may be geographically located remote from the job providers 102. For example, the job provider client 212 and job processor server 204 may be located in a developed country with good network connectivity and the respondent server 202 and respondent devices 206 may be located in a developing country with poor network connectivity. In this case, buffering may be performed between the job processor server and the respondent server in order to decrease latency and data loss. This buffering may be performed by components of the respondent server 202 and job processor server 204, or it may be performed by other computers and additional networks.

In another embodiment, a simplified network configuration may be used, where the respondent devices 206, respondent server 202, job processor server 204, and job provider client 212 are all connected to the same network (e.g., the Internet). This may be used if all the devices have good connectivity to the same network. In one embodiment, the job processor server 204 and respondent server 202 may be the same computer.

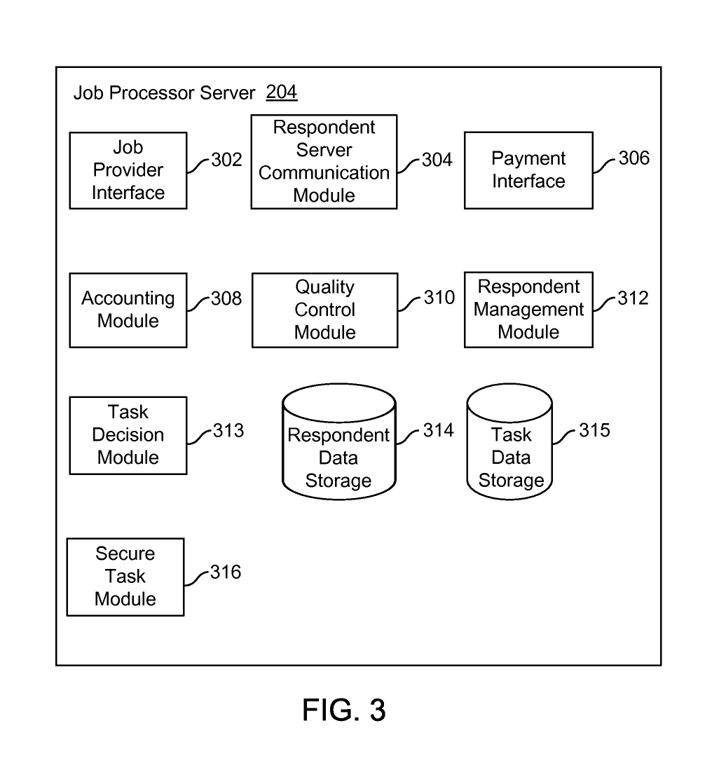

FIG. 3 is a block diagram illustrating the job processor server 204, in one embodiment. The job processor server 204 includes a job provider interface 302, a respondent server communication module 304, a payment interface 306, an accounting module 308, a quality control module 310, a respondent management module 312, a task decision module 313, a respondent data storage 314, a task data storage 315, and a secure task module 316.

The job provider interface 302 interacts with the job provider client 212. In one embodiment, the job provider interface 302 includes a web server to provide the job provider client 212 with a web-based interface to submit jobs and receive results. The respondent server communication module 304 communicates with the respondent server 202, including sending tasks (possibly in bulk) and receiving responses. The accounting module 308 determines rewards to be given to respondents for their completion of tasks. The payment interface 306 handles payment transactions with the job provider and respondents. The payment interface 306 may interface to various financial payment systems. These processes are described in more detail below.

The quality control module 310 determines the quality of respondent responses and job results. The respondent management module 312 keeps track of respondents, including information about respondents, relationships between respondents, and past performance of respondents. The task decision module 313 divides jobs into tasks and delegates tasks to respondents. The respondent data storage 314 stores information about respondents. This information may be stored by the respondent management module 312 and accessed by the task decision module 313. The task data storage 315 stores information about tasks, such as the tasks needed for a particular job and the status of these tasks (e.g., delegated, completed, etc.). The task data storage 315 may be accessed by the task decision module 313. In one embodiment, the respondent data storage 314 and task data storage 315 are stored on a storage device of the job processor server 204. The secure task module 316 receives a job including secure information, divides the job into tasks such that the secure information cannot be detected from an individual task, and distributes the tasks among various job respondents 106. These processes are also described in more detail below.

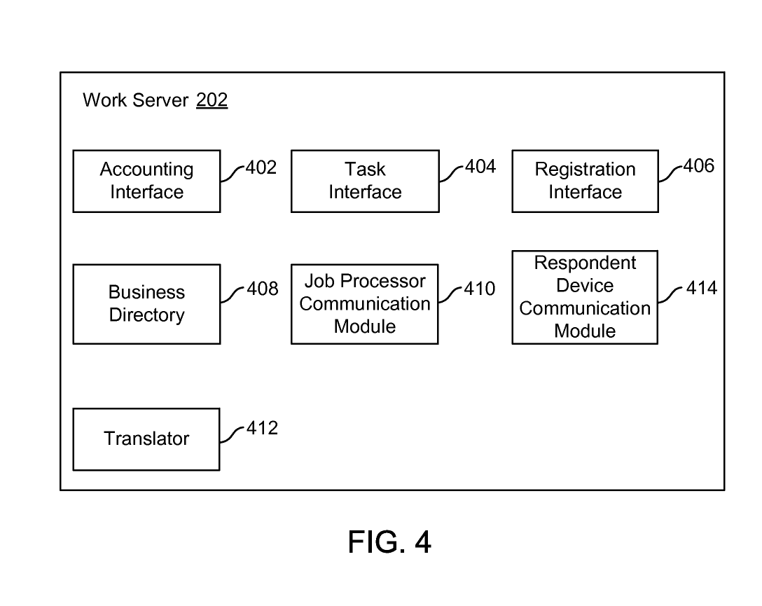

FIG. 4 is a block diagram illustrating the respondent server 202, in one embodiment. The respondent server includes an accounting interface 402, a task interface 404, a registration interface 406, a business directory 408, a job processor communication module 410, a translator 412, and a respondent device communication module 414.

The accounting interface 402 provides an interface to respondent device 206 for rewards. For example, a respondent device can check rewards or be notified of rewards by the accounting interface 402. The task interface 404 notifies respondent devices of tasks, receives task responses, and provides an interface for other task-related issues. The registration interface 406 enables respondents to register through respondent devices, and it receives and processes registration messages. The job processor communication module 410 handles communications with the job processor server 204, which may include buffering of information to be transmitted over the job processor network 210. The respondent device communication module 414 handles communications with the respondent devices 206, which may include buffering of information to be transmitted to the respondent devices 206 over the respondent network 208. For example, the respondent device communication module 414 may convert tasks into text messages and provide them to a Short Message Service (SMS) gateway or an Unstructured Supplementary Services Date (USSD) gateway.

The business directory 408 may include a directory of local businesses that can be used for task generation or delegation as further discussed below. The translator 412 can translate messages into a language understood by respondents. For example, a task may be received from the job processor server 204 in one language, and the task can be translated into another language before being sent to the respondent device 206.

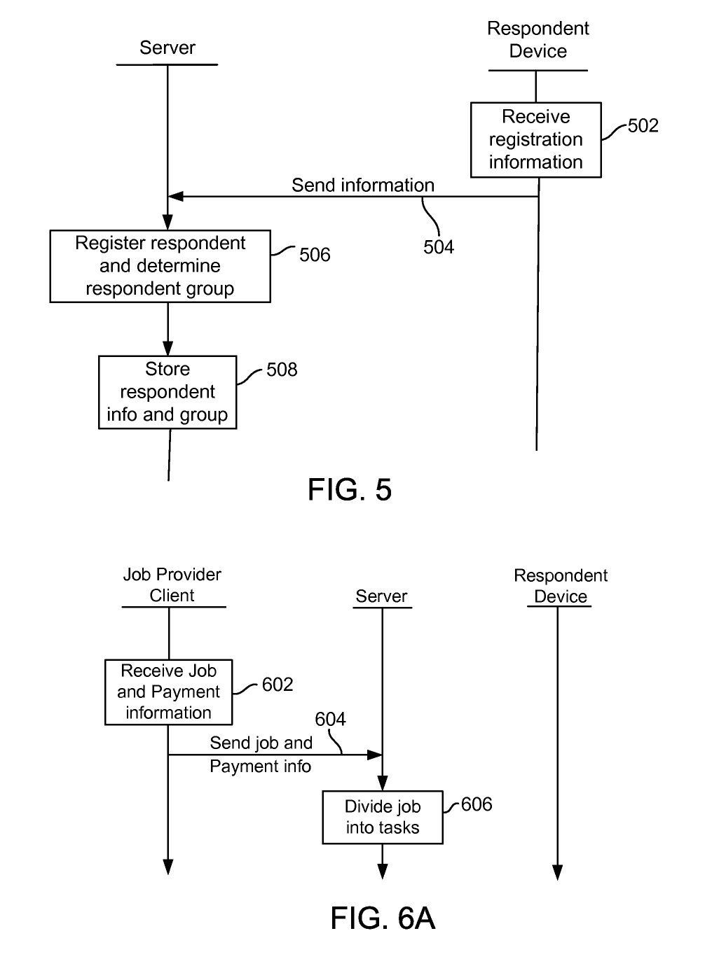

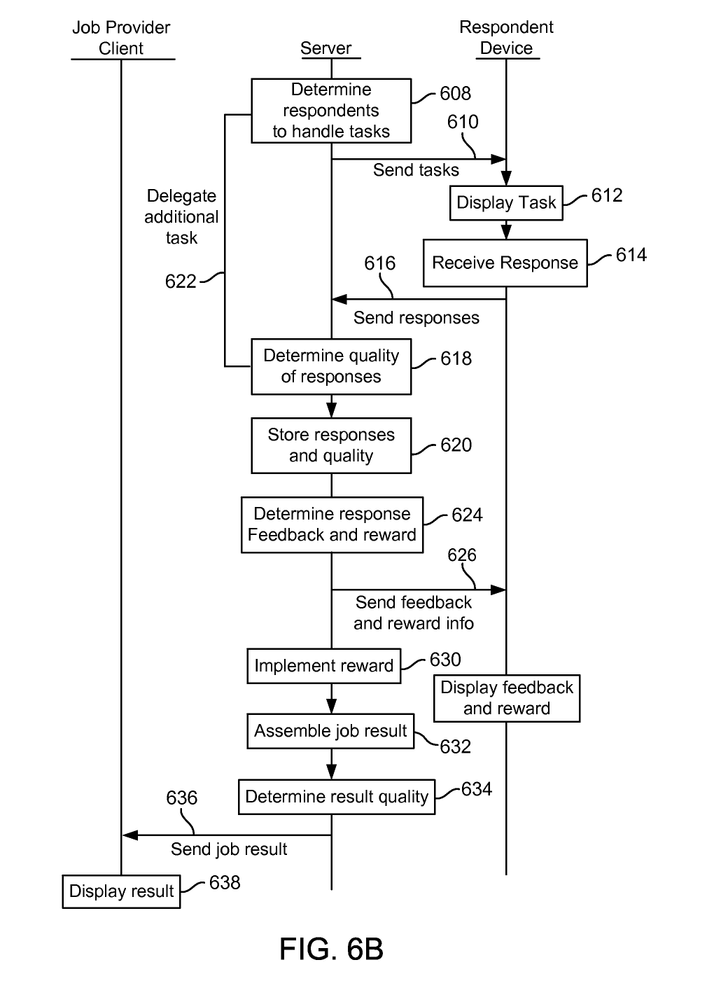

Some of the functionality of the respondent server 202 described above may be included in the job processor server 204, in some embodiments. Similarly, some of the functionality of the job processor server 204 described above may be included in the respondent server. Also, as mentioned above, the job processor server 204 and the respondent server 202 may be the same computer. In the processes illustrated in FIGS. 5-6 and described below, the job processor server 204 and respondent server 202 are combined into a single entity, which is referred to as the “server” for ease of description. In an embodiment with a separate job processor server 204 and respondent server 202, the job processor server 204 and the respondent server 202 communicate with each other to perform the functions of this server.

### Tracking and Managing Respondents

FIG. 5 illustrates one embodiment of a process for registering a respondent 106. As mentioned above, respondents may register with the system so that they can be tracked and delegated appropriate tasks. Initially, registration information is received 502 at a respondent device 206 from the respondent (e.g., input into a user interface of the respondent device 206), and this information is sent 504 to the server. For example, a respondent may enter a text message into his or her respondent device 206 that includes various registration information and then sends the text message to a phone number or SMS code associated with the server. The respondent may have previously been given instructions on what to include in the text message and what number to send it to. In one embodiment, the respondent may input and send data multiple times during registration. For example, the respondent may send a first text message with some information, receive a response from the server, and then send further information in a second text message. In one embodiment, registration information is provided via a web-based form that is displayed on the respondent device.

The information sent to the server from the respondent device 206 may include various types of information about the respondent and other information that may be of relevance in delegating tasks, evaluating responses, or determining rewards. Examples of information include the name of the respondent, the location of the respondent (e.g., city or postal address), age, gender, or other demographic or socio-economic information. Further information may include the respondent's desired types of tasks (discussed further below), the respondent's desired quantity of tasks, and the times that the respondent is available to do tasks (e.g., time of day, days of week). The information may also include how the respondent desires to be rewarded. For example, the respondent can provide a bank account number for cash rewards to be deposited, or the respondent may provide the details of a wireless services account and indicate that the respondent prefers to be rewarded with value (e.g., as measured in some kind of currency units) added to the balance of that wireless services account. The respondent may also provide information to set up secure future interaction with the system, such as various login questions and answers or a password. Additionally, if the respondent device is a cell phone, the server will receive the cell phone number. This number may be used by the server to uniquely identify the respondent in the future.

In one embodiment, a respondent 106 can register other respondents or otherwise indicate a connection to one or more other respondents. A respondent may serve as a manager of other respondents and be responsible in various ways for those respondents. In many cases, a manager will personally know his or her subordinates and be able to supervise them outside of the system 200 through personal interaction. For example, a manager may be an adult that is responsible for a group of poor or at-risk teenagers. The manager may register all of his subordinate respondents and specify himself as their manager. He may then be rewarded if they subsequently perform well on tasks and penalized if they do not, as further described below. He may also have the power to enable or disable their working privileges at any time. For example, if one of his subordinate respondents engages in undesirable behavior, such as skipping school or using illegal drugs, the manager can temporarily halt his working privileges and prevent him from completing tasks or receiving rewards for a certain period of time. In one embodiment, a respondent may also indicate respondents that he or she knows, even if the relationship is not a managerial one.

Information about personal relationships that are provided to the system 200 may be useful for task delegations and reward determinations. Since a manager may be rewarded or penalized based on the performance of subordinates, the manager may exert influence on subordinates to perform well and provide them with additional motivation. Also, the manager may be able to provide more details about the subordinates' skills and abilities to the system 200 to enable better delegation of tasks to the subordinates. Managers may also be motivated to recruit new respondents to perform tasks for the system 200. Information about non-managerial relationships may also be useful in task delegations, as some tasks may be designed to be worked on cooperatively by a group of respondents offline. In such a cooperative task, the rewards of all the involved respondents may depend on the quality of completion of the task, resulting in peer pressure among members of the group to perform well.

Returning to FIG. 5, the server registers 506 respondents and may also determine respondent groups. In one embodiment, registration involves storing registration information associated with a respondent in the respondent data storage 314. The respondent data storage 314 may be a database in which each row corresponds to a respondent having a unique identifier (e.g., cell phone number) and the columns correspond to types of information about the respondent.

Respondent groups to which the respondent belongs may also be stored in the respondent data storage. One type of group is a group formed by the associations discussed above. For example, a manager respondent and associated subordinate respondents may be considered a group. Another type of group is a group that is formed based on commonalities in registration information. For example, respondents living in the same city may be placed in a particular group even though they do not indicate knowing each other during registration. Respondents of similar ages, respondents having similar skills, and respondents having other similar traits may be placed into groups. Groups may be useful for task delegation purposes as described further below.

In step 508, the server 204 stores respondent information and group information in the respondent data storage 314, e.g., in a respondent profile for each respondent. The server may then send a confirmation of registration to the respondent device, which displays the confirmation to the respondent. Once a respondent has been registered, the respondent is eligible to receive and perform tasks, and be rewarded for doing so, as described below.

### Performance of a Job by a Distributed Group of People

FIGS. 6A and 6B illustrate a process for managing the performance of a job by a distributed group of people, in one embodiment. A job is received 602 from a job provider via a job provider client 212. For example, the job provider may enter job information into a form on a web browser running on the job provider client 212. The job provider may have previously registered with the system 200 and set up an account with the job processor server 204.

Payment information may also be received 602 from the job provider. The payment information may include an amount specifying how much the job provider is willing to pay. Moreover, the job provider may select from a number of options regarding the cost of the job versus a degree of accuracy of the result (where a higher level of accuracy of the result costs more, because it more likely involves more tasks sent to individual respondents, and thus more cost to the job processor). The payment information may also include a method of payment, such as a credit card number, bank account, or other source of funds. Different payments may be specified for different levels of completion of the job or different qualities of results. The job information and payment information is sent 604 to the server.

The job may be any of a wide variety of jobs that may be broken down into several tasks to be performed by the distributed group of people. One example of a job is to translate a book from one language into another. For such a job, the job provider may send the text of the book along with an indication of the desired translation language to the job processor server. Another type of job is image tagging and/or classification. For example, the job provider may have thousands of images taken from a vehicle while driving down a road, where an image is taken every few seconds along the road. The job provider may desire to have each image tagged to indicate whether the image includes a street sign as well as the contents of the sign. Another type of job is entry of data from scanned data entry forms. For example, the job provider may have many scanned forms, where the forms each have several fields containing handwritten information that must be added to a database.

Jobs may also include the classification of various types of documents. For example, a job may be to determine whether various emails from customers are “angry” or not. Based on results provided by the job processor server, the job provider may then take a closer look at these emails to determine what actions might be taken to placate the angry customers. The results of jobs need not be limited to binary classifications. For example, a job may request that various degrees of anger be identified in emails. Alternatively, the job may request a short sentence describing each email. Other types of jobs may involve obtaining classifications, descriptions, or transcriptions of various media items, including images, videos, and audio recordings.

A job may also have multiple stages. For example, a job provider may provide various scanned filled-in paper forms to the job processor server 204 and request that the job processor server 204 digitize the forms and the filled-in values. The job processor server 204 may initially determine the form fields and set up a database having those fields. The job processor server 204 may then create the database records having those fields with the filled-in values.

In addition to processing information provided by the job provider, jobs may involve obtaining new information. For example, a job may be to assemble a directory of businesses in a particular city that includes business names, descriptions, addresses, and photos. The job provider may merely specify the city to the job processor server 204 and rely on the job processor (using the distributed group of people) to obtain the desired business information for the city.

Division of a Job into Discrete Tasks

In step 606, the job is divided into tasks. Task division may be performed by task decision module 313. Jobs may be divided into tasks in a variety of ways. In one embodiment, jobs are divided into tasks that are independent of each other and that can be performed by separate respondents. Various factors may be taken into account when dividing jobs into tasks, including the size or difficulty of individual tasks, the ability to verify task responses, and the ability to assemble responses into a job result. Particular tasks may be dependent on completion of other tasks. For example, the first phase of a job may involve a certain types of tasks, while the second phase may involve different types of tasks that work on the responses from the first phase.

Another type of task is a verification task, which may be used to verify the quality of another respondent's response to another task. A verification task may involve a respondent reviewing the previous response of another respondent and specifying whether or not it is correct. Verification may also be performed by simply delegating the same task to multiple respondents and analyzing the responses from the multiple respondents to determine the likely best response and its likelihood of being the best. Verification tasks may be sent to respondents who are known to have higher skill levels, higher dependability, or a better past performance record than respondents performing standard tasks.

For example, if a job is to translate scanned pages of a book from a first language to a second language, a first set of tasks may be to transform the scanned page images into text characters of the first language, also known as optical character recognition (OCR). Much of the OCR can be performed by automated OCR algorithms. However, the algorithms may fail on certain images of words or phrases, and these images of words or phrases can be sent to respondents as manual OCR tasks. The respondents respond with text corresponding to the images. For each image sent out as a task, the job processor server 204 maintains information specifying the location of the image in the book so that the respondent responses can be inserted at correct places in the text of the book. Verification tasks may also be created to verify the correctness of the manual OCR tasks. Continuing this example, a second stage of tasks would involve translating the text from the first language to the second language. For this stage, the book can be divided into sentences or paragraphs, and each of these text fragments can be sent to individual respondents as translation tasks. The respondents provide responses including the requested text in the second language. Since OCR has already been performed, text fragments can be easily sent to respondents as text messages, for example. As with the first stage, the job processor server maintains information to enable the responses to be assembled in a correct order to produce a translated book as the final job result. Verification tasks may also be created at this stage.

### Delegation of Respondents to Perform the Tasks

The server then determines 608 respondents to handle the tasks. The task decision module 313 may communicate with the respondent management module 312 to retrieve information about possible respondents from the respondent data storage 314. Task delegation decisions may be based on many factors, including data provided about respondents during registration (or subsequent update of registration information), and including data learned about respondents from their past performance of tasks. In the example discussed above about translating text from a first language to a second language, respondents can be chosen who are known to understand both the first language and the second language. This can be determined from their registration information (e.g., language skills indicated while registering). It can also be determined from their past performance of tasks, such as whether they have been able to successfully complete tasks in the past in both of those languages. The translation skill of potential respondents can be determined from the respondents' performances on past translation tasks.

As described further below, when a respondent completes a task, the quality of completion may be determined and stored. The information regarding the quality of a respondent's performance on previous tasks maybe used to delegate subsequent tasks. Various attributes of respondents may be learned based on their past performance, including: overall response quality, response quality for different sorts of tasks, quality of responses for tasks requiring particular knowledge or skills, response time, and dependability (e.g., likelihood of receiving a response). Models can be constructed of respondents based on this information to predict their likely future performance on various tasks, and these models may be used to delegate subsequent tasks. In one embodiment, a machine learning model is trained using many respondents' attributes and their performance on tasks, and this trained model is then used to predict a respondent's performance on future tasks. These predictions may be used to determine which respondent's to delegate which tasks, as discussed herein.

Tasks may also be delegated based on respondent groups 108. Respondents in a particular group may share a common characteristic or otherwise have a relationship among the group members, as mentioned above. If a task requires respondents having a particular characteristic (e.g., a skill in a particular language, or a location in a particular city), then the population of respondents eligible for the task may be limited to an appropriate respondent group. Respondent groups may be used to delegate tasks to respondents who personally know each other, if such a delegation is necessary or is likely to provide increased motivation to the respondents to perform the task well. Conversely, respondent groups may be used to delegate tasks to respondents who are unlikely to know each other personally (e.g., who live in different cities) if a lack of connection among the respondents for a given job is desirable for security or verification purposes.

In one embodiment, the job processor server 204 does not have knowledge of the current status of specific respondents when delegating tasks. For example, the job processor server 204 may not know which respondents are currently online and available to receive tasks. In this case, the job processor may determine the required characteristics of potential respondents (e.g., particular respondent groups needed). This information may then be sent to the respondent server 202, which can then choose individual respondents for task delegations. In another embodiment, respondents send messages to the respondent server 202 indicating when they are available to receive new tasks. For example, a respondent may indicate that he or she is willing to receive tasks during the next six hours, or some other time period. In this embodiment, the job processor server 204 may delegate tasks to respondents based in part on the respondents' stated availability o perform the tasks.

The tasks are sent 610 to the respondent devices and displayed 612 to the respondents. Tasks may include instructions for performing the task and possibly data for processing, such as text, images, audio, or video. The respondents then perform the tasks. Task performance may involve manipulating or processing the information provided in the task or may involve the respondent obtaining information from outside sources and/or performing some other type of work. Upon completion of the task, a response is received 614 by the respondent device 206 from the respondent. For example, the respondent may enter a text response into his or her cell phone. The task response is then sent 616 to the server.

The server then determines 618 the quality of responses received. As mentioned above, this can be performed through the use of verification tasks. In one embodiment, a specially trained and trusted pool of people may verify a certain fraction of responses (or all responses). Response quality may also be determined through various other methods, such as automated algorithms that can detect clearly incorrect responses (e.g., where a 50-word paragraph is translated into a single word of another language). The received responses and the quality measures determined for the responses are stored 620. In one embodiment, additional tasks may be delegated 622 after some responses are received. If any task responses are determined to be of low quality, the same tasks can be re-delegated to other respondents.

If the server is unsure of the quality of a response, the same task can be sent out to multiple respondents to determine the correct or best response. For example, the server may look at subsequent responses to confirm a previous response. If the responses from multiple respondents differ, the correct or best response may be determined according to the frequency of each response and/or the reliability of the respondents providing the responses, among a number of other factors. If task responses of acceptable quality are received, tasks corresponding to the next stage of the job can be delegated and sent to respondent devices 206 (in the example above, translation tasks can be sent out after receiving quality responses to OCR tasks).

### Rewarding Respondents for Completing Tasks

Response feedback and rewards are then determined 624 for the responses received. The feedback for a given respondent's response may indicate the quality of that response. The feedback is useful because it communicates to the respondent how well the task was performed, which enables the respondent to improve performance for future tasks and incentivizes the respondent to do so. The feedback may be expressed as a binary (e.g., good or bad) or numerical (e.g., “5 out of 5 stars”) value, and it may include written indications of quality or other relevant notes (e.g., “75% of verifiers disagreed with your response” or “You did not respond within the requested three-hour period”). The feedback may also include suggestions for improving the respondent's future responses (e.g., “Please provide a shorter response in the future”). Feedback may be provided for individual responses from the respondent, or it may be provided to the respondent in the aggregate for multiple responses. In a hierarchical arrangement of respondents, the feedback may be provided to the respondent and to any of the respondent's supervisors.

Rewards may be determined based on a variety of factors, including the quality of the respondents' responses and the difficulty of the tasks. The server may determine the quality of the responses using various techniques, as discussed above, including by delegating verification tasks to other respondents. Moreover, the difficulty of a task may be determined in many ways, such as by receiving an indication of the difficulty from the job provider or the job processor, or by requesting the opinion of other respondents about the difficulty of the task. For example, one type of respondent task may be to rate the difficulty of other tasks, such that one respondent's response to a task is used to determine the compensation for another respondent's response to a different task.

In one embodiment, respondents are compensated based on an expected value of their responses to the system. For example, a system may delegate the same task to several respondents until a threshold confidence level is reached for the task, at which time the system determines the correct response for the task within an acceptable margin of error. In such an embodiment, the system may keep track of each respondent's reputation to predict how often the respondent is expected to provide a correct response. A respondent's reputation may be based on the historical accuracy of the respondent's responses. For more accurate respondents, the system would expect to need to delegate the same task to fewer respondents to achieve the necessary confidence level for the task. This is in part because less accurate respondents need more confirming responses before the system can reach the necessary confidence level for a response. Since the system pays respondents for their responses to tasks, fewer delegated tasks results in a lower cost to the system. Accordingly, the expected value of a response from a more accurate respondent is higher than the expected value of a response from a less accurate respondent, regardless of the content of the responses. The system may thus compensate respondents differently based on the accuracy of their responses to previous tasks, and this compensation need not take into account the accuracy of the response for which a respondent is presently being compensated.

More generally, respondents may be compensated for their responses during one period based on their performance during one or more previous periods. This way, respondents will earn a known, stable pay for their tasks for a given period, but they are also motivated to perform well. With a higher performance during one period, a respondent can effectively earn a raise for the subsequent period. But with a poor performance, the respondent may earn much less in the next period. In such a scenario, the respondent with poor performance may be motivated to quit, which would be a small loss to the system. Alternatively, a respondent with poor performance could attempt to improve that respondent's reputation with a good performance, and thus earn a higher compensation. Beneficially, this provides a path for a respondent to rehabilitate the reputation while requiring less investment, since the respondent is earning less during this time.

In one embodiment, respondents are compensated only if their responses are correct, or at least verified. For example, a response may be verified by other respondents' responses, after which the respondent may be compensated for the verified response. The verification process also provides opportunities to motivate respondents using compensation. For example, a respondent may be delegated a task that comprises verifying another respondent's response, and the respondent may be compensated for identifying an error in the other response and/or for improving or adding to the response being verified. In addition, a respondent whose previous response was declared to be incorrect (e.g., based on other respondents' responses to a verification task) may be given the opportunity to post a bounty from the respondent's own account to “re-grade” the response. If the response is then verified, the respondent keeps the posted bounty and also receives additional compensation; otherwise, the respondent loses the bounty, which is used by the system to offset the costs of reevaluating the response.

Variable rewards and other types of reward distributions may be used to motivate respondents to provide high-quality responses. Among various compensation schemes, the respondents may be compensated additionally by improving their quality, accuracy, and/or response time. For example, a respondent may receive a bonus compensation for providing a certain number of consecutive correct answers, for achieving a certain accuracy percentage over a period of time or series of tasks, or for providing a certain output of responses during a given period. Respondents may also be paid for responding to surveys or questionnaires. Further, respondents may be compensated for performing tasks in the real world, which may or may not relate to a delegated task from the job processor. Such tasks may include interviewing someone, recording answers, participating in a “secret shopper” program, rating a consumer experience (e.g., confirming that an item is purchasable), going to a location and gathering or verifying Point of Interest (POI) data, delivering a package for someone (e.g., to help to solve the last mile delivery problem), or any of a variety of actions that can be performed in the real world.

Rewards may also be given to managers for tasks performed by subordinate respondents. Good performance by subordinates may result in a bonus being given to the manager, while poor performance by subordinates may result in reduced rewards being given to the manager. This encourages the manager to motivate his or her subordinates to perform more tasks and to perform them well. The compensation in a hierarchical system may also be based on the respondent's title. This additional compensation reflects the additional responsibility that accompanies a managerial role, and it encourages other respondents to strive for a promotion through good performance of their tasks. Rewards may also be given to an entire group of respondents if the respondents as a whole perform tasks well. This also encourages members of a group to motivate others in the group to perform well.

Various forms of rewards may be used, including cash payments, credits to various stores, or redeemable coupons. In one embodiment, the reward is a direct payment to a debit card or bank account associated with the respondent. If the system does not have access to a bank account for the respondent, the system may set up a bank account for the respondent at a bank that is local to the respondent, fund the account, and give information to the respondent necessary to access the account. In another embodiment, the reward comprises an addition of value (e.g., measured in some form of currency) to the wireless services account associated with the respondent and/or associated with the respondent's cell phone (which may also serve as a respondent device 206). This may be particularly attractive for respondents on prepaid cell phone plans. In some markets, currency stored in the balance of a wireless services account can be redeemed as real cash (at some local transaction cost) or sent to another person's wireless services account, as a gift or as a payment in exchange for goods, services, etc.

In another embodiment, the reward provided to the respondents comprises a PIN-based “gift certificate,” which may or may not be associated with a physical gift card. Accordingly, the PIN associated with the gift certificate can be freed from the card and sent directly to a respondent's mobile phone or other computing device. The respondent can then redeem the certificate locally. In addition to being redeemable at retail stores or restaurants, the gift certificates may be associated with costs of living, such as electricity bills or rent, or broadly with anything that a respondent may need to pay for.

The reward may include a variety of other types of economic benefits for the respondent. For example, the reward may include a fee reduction or partial payment of costs on behalf of the respondent (e.g., tuition for school, trade programs, or other training to benefit the respondent). The reward may also include payment in the form of virtual currency, which may enable online purchases of games, music, movies, or any other computing resource that may be purchased using virtual currency. In one embodiment, the value of the reward (regardless of its form) is randomized. In such an embodiment, the value of the reward may be set randomly, similar to a lottery ticket, where the value has a chance of being relatively large. The random-value reward may also be set with a nonzero minimum to guarantee that the respondent earns at least some value. Alternatively, the reward may simply comprise one or more entries to a raffle, where more entries provide the respondent with a greater chance to win the prize. In another embodiment, the reward may include a payment to a charity, possibly chosen by the respondent, either anonymously or on behalf of the respondent.

The reward may include non-economic benefits for the respondent. In one embodiment, respondents who have performed well may be “promoted” in various ways, and notice of this promotion can be sent to the respondent along with the feedback. The reward may also include providing the respondent with symbols of the increased status, such as by “badges” that may be displayed via the respondent user interface portal and visible to the respondent's associates and/or friends. In this way, respondents may be motivated to perform well so as to achieve levels of status within their social circles.

After performing certain tasks well, a respondent may become qualified to verify or otherwise monitor the performance of other respondents on various types of tasks. A respondent may also be promoted to a supervisory role and delegated subordinate respondents, and a new respondent group may be created similar. As discussed above, the compensation scheme may allow a respondent who has a managerial role to receive increased rewards for the tasks performed by respondents under that manager respondent. Through promotion, a respondent may become qualified to take on different kinds of tasks (e.g., more difficult and more important tasks, which may lead to higher payments).

Even in the absence of a specific promotion to a different respondent role, a respondent may be rewarded with a certification. A certification may indicate that the respondent is specially qualified to perform certain tasks (such as translation tasks). Defining different fields of certification may provide the system with a better mechanism to evaluate a respondent's responses and to compensate the respondent for them. For example, a respondent who is certified only in translation may have better opportunities for tasks that relate to translation, but not tasks that relate to image recognition. Also, respondents who have been certified for a particular skill may be made directly available to potential employers in a real world marketplace setting, rather than in a strictly managed environment of the distributed group of people discussed herein.

Other non-economic rewards may include access to information, the Internet, or generally to computing resources. For example, the respondent may be compensated by providing the respondent with access to sports information, weather information, information on how friends did with similar work, training information related to how to perform tasks more efficiently or profitably, or any other type of information that is relevant to a particular respondent. The information may be provided in various ways, including over the same network used to send the tasks. Rather than specific information, the compensation may comprise providing the respondent with Internet access, such as through mobile phone providers, ISPs, or cyber cafes (which is beneficial where the respondent does not own his or her own hardware). For example, a respondent may need to do a small amount of work before he or she can check e-mail.

In another embodiment, the respondent's reward may simply be to work on a system that is being completed by the respondents. For example, a job may be to build a database of local knowledge, such as restaurant reviews. While some users may pay for use of the online service, the respondents who are contributing to it may be compensated with the ability to access the service. This compensation scheme may be especially relevant when related to local knowledge outsourcing, where the task relates to learning and verifying locally-relevant information such as prices, locations, ability of services, and the like.

Another type of possible reward to the respondent is to provide the respondent with economic opportunities, rather than or in addition to direct payment to the respondent. For example, the respondent may be given more access to tasks or access to different types of tasks, or the respondent may be given the ability to give friends or acquaintances these opportunities. This may allow the respondent to recruit others (for additional compensation), to train others, to edit the work of others, or to work on more difficult—but better paying—work.

In another embodiment, the compensation may include the ability to vote for something, such on an issue related to work and compensation. The more rewarded the respondent, the greater voice that the respondent has in how the issue is resolved. The voting may also be on an issue that has no effect on the respondent, such as an opinion poll.

As mentioned above, respondents may provide information regarding their reward preferences and reward receipt methods at registration. This information can also be updated and revised by the respondents. The feedback and reward information is sent 626 from the server to the respondent device and then displayed 628 to the respondent on the respondent device. The reward is implemented 630 by various methods depending on the type of reward. Rewards may be provided per-response or in the aggregate (e.g., a single reward for all responses sent each week).

A cash reward may be implemented by sending a payment to a respondent's bank account. An airtime reward may be implemented through an interface with an appropriate cellular service provider's account systems. The rewards may be directly paid to an external account for each respondent, or the rewards may be initially added to each respondent's local account that is managed by the server. The respondents may log into the server to manage their accounts, see their account balances (i.e., the money that they've earned), and request to be cashed out. In response to the cash out request, a respondent may direct the payment (e.g., to the respondent's bank account, wireless services account, etc.), and the server then transfers money in accordance with the respondent's instructions. In one embodiment, the payment interface 306 implements the reward.

### Assembling and Providing the Final Result

The server assembles 632 the overall job result from the received task responses. As discussed above, the server may store ordering information regarding the tasks so that the responses can be assembled in the correct order. In one embodiment, the quality of the job result is determined 634 before providing the result to the job provider. The quality of the job result may be determined by applying various algorithms to the known or likely quality of the individual task responses. A determined quality level of the job result may be compared to a threshold quality level for deciding whether the result is of sufficient quality for it to be sent to the job provider. If the result is deemed to be of insufficient quality, further tasks can be sent to respondents as described above to produce a higher quality result.

The job result (e.g., the translated text of a book) is sent 636 to the job provider client 212, which may communicate information summarizing the result and/or the quality of the result to the job provider 102. The job provider client 212 may communicate this information to the job provider 102 using any of a variety of mechanisms. For example, the job provider client 212 may display the information to the job provider 102 in a web-based interface. Alternatively, the job provider client 212 may store the information in a computer-readable medium and make it available for downloading by the job provider 102. The job provider client 212 may even make a hardcopy of the information and send it to the job provider 102. In other embodiments, the information need not be communicated to the job provider 102. For example, the job may involve obtaining information about businesses in a city, and the job provider 102 may just have the job processor 104 update an online directory about the city with the job result. Accordingly, the information about the result may be provided to a third party, or the job result may comprise a performed task that need not result in information to be communicated to the job provider 102 (e.g., where the job is the delivery of a package to a physical address).

### Performance of a Job Involving Confidential Information

Jobs often involve confidential information, such as credit card numbers, images of people, and the like, and the processing of tasks to complete the jobs may require use of the confidential information to complete. Since a distributed group of people is likely to be relatively unsecured, the owner of the confidential information would typically desire a mechanism to protect this information. Accordingly, embodiments of the invention provide mechanisms to secure confidential information by providing tasks to respondents 106 so that the confidential information related to the job is not easily discernable by a respondent 106 or a group of respondents 106 in communication with each other.

Referring to FIG. 6A, a job provider client 212 transmits 604 information about a job to job processor server 204. The received information includes information required to perform the job, including an identification of confidential information that the job provider client 212 wishes to protect. For example, the received information may include a set of documents that need to be processed in a particular manner as part of the job. Additionally, the job processer server 204 receives information from job provider client 212 indicating that the job includes confidential information. In one embodiment, the transmitted information also pinpoints the confidential information in documents associated with the job. For example, the documents include metadata that identifies particular words, sentences, paragraphs, or pages as comprising confidential information.

After receiving the information, the job processer server 204 divides 606 the job into tasks so that the confidential information is not discernable by the divided tasks alone. The job processor 204 may apply a number of techniques to prevent a respondent 106 from determining confidential information associated with the task. To protect the confidential information, the job processor server 204 may shred, distort, and/or distribute data associated with the job (hereinafter “job data”) into various data for various individual tasks (hereinafter “task data”). For example, if the job includes gathering data including confidential data, the job processor 204 may divide the data to be gathered amongst multiple respondents. Accordingly, none of the respondents gather all the desired data and the respondents are therefore hindered from identifying or discerning the purpose or value of the gathered confidential data. In another example, the job processor 204 may further hide the value of confidential data by delegating a task to a respondent that requires collection of additional data that may be unrelated or not as important as confidential data being collected by the respondent while performing the same task. The collection of additional data may help in confusing, misleading, and avoiding the respondent from discerning the confidential data or purpose of the data being gathered.

Data Shredding

The job processor server 204 shreds or divides the job data into smaller task data chunks such that the individual chunks do not include enough information for a respondent 106 to discern confidential information. At the same time, the chunks contain sufficient information to allow a respondent 106 to perform the required a task. To determine how to divide the data in this manner, the job processor server 204 analyzes the metadata associated with the job data and divides the job data based on the metadata analysis. For example, a medical record containing information on a patient includes confidential information. However, the medical record is confidential only if it includes adequate information to identify a patient. Without identification information, a record cannot be associated with a patient, and therefore the patient's privacy can be protected. In this example, the job processor server 204 may analyze the metadata associated with the patient's record to determine the location of patient's identification information in the medical record.

The patient's identity in a medical record can then be masked or protected in a number of ways. For example, the job processor server 204 may separate the patient's first name, last name, and social security number into different task data chunks. Each of these individual data chunks is not as sensitive as they are when combined together. To further obscure the confidential information, these data chunks may be further divided. For example, the job processor server 204 may divide the task data chunks such that the first half of the patient's social security number is separated from the last half.

Accordingly, the job processor server 204 may divide the job data into smaller chunks of task data such that data for a particular task does not divulge the confidential information in the job data. Additionally, the job processor server 204 ensures that the job data is not divided in a manner that makes a chunk of divided data unsuitable for processing separate from other task data chunks. The job processor server 204 ensures proper division of job data using various techniques like maximum safe size analysis, known framework analysis, metadata analysis, summary analysis, and break analysis. These techniques are described below.

Safe Size Analysis

In one embodiment, the job processor server 204 determines whether data chunks of a maximum safe size can be separately processed by respondents 106 without knowledge of other data chunks of the job data. Accordingly, the job processor server 204 divides the job data into chunks and provides the chunk to a simulated respondent. The job processor server 204 then receives feedback from the simulated respondent to determine the accuracy of the processed results. The job processor server 204 varies the size of data chunks and repeats the above mentioned steps. The job processor server 204 repeats these steps until the job processor determines a chunk size that is small enough and yet provides acceptable results. The determined chunk size is the maximum safe size.

In one embodiment, the job processor server 204 creates multiple task data sets from the same job data using different offsets or orientations. These different sets minimize errors in job results caused by the maximum safe size being too small. For example, the job processor server 204 receives a photograph as job data for a job involving identifying the location of human faces in a photograph. If the job processor server 204 divides the photograph into chunks that are too small, none of the data chunks may include adequate information to identify a face. To minimize the occurrence of such scenarios, the job processor 204 creates multiple task data sets from the same job data.

Accordingly, the job processor server 204 divides the photograph into chunks of maximum safe size starting from one edge of the photograph. The job processor 204 next creates another task data set by dividing the same photograph starting from a different edge or different orientation. The job processor 204 can also create different task data sets by dividing the photograph using different offsets from an edge. The job processor server 204 then transmits chunks from different task data sets to different respondents. Because different task data sets include chunks made from different orientations and different offsets, the job processor server 204 beneficially increases the likelihood that one or more of the task data chunks would include adequate information to identify the location of a face.

Known Framework Analysis

If the job data has a regular framework, i.e. a predefined format or form, the job processor server 204 first determines how to divide the framework before the framework is populated with confidential data. For example, a form used to record a medical patient's information is a framework for entering patent's confidential data. The form includes various placeholders for patient's name, social security number, and other personal information. The job processor server 204 determines or otherwise receives the location of these placeholders in the form and creates rules for dividing the forms so that the patient's confidential information is divided into various task data. Because the unpopulated form does not include confidential information, the job processor server 204 may delegate the task of locating the placeholders to an unsecure respondent if required. Alternatively, the job processor server 204 analyzes the metadata for the form to determine the placeholders' location. The job processor server 204 then uses the created rules to divide the medical forms populated with patient data into task data.

Pre-Processing Analysis

For pre-processing analysis, the job processor server 204 pre-processes the job data in a secure environment to create a probability map indicating the most likely locations of confidential data. The job processor server 204 then separates the confidential data from the job data based on the probability map.

For example, an audio recording intended for transcription to text may be pre-processed using audio processing algorithm for existence of names. This process may be much faster and less expensive than trying to securely transcribe the audio file. If names are confidential, the job processor server 204 divides the audio into smaller chunks so that the confidential names are separated from their context or are not audible in any individual task data chunk. Other examples of pre-processing include 1) applying facial-recognition software to images to determine probable location of people's faces in a video or an image, and 2) applying optical character recognition software to determine the probable text in a hand-written note. The pre-processing analysis beneficially increases the ability of the job processor server 204 to identify confidential information in job data and divide the job data into task data so that individual task data is not adequate to discern confidential information

Summary Analysis

Summary analysis is another technique the job processor server 204 may use to divide job data into task data to protect confidential information in the job data. To split the confidential information into multiple task data, it is helpful to determine the location of confidential information in job data. The job processor server 204 may delegate the task of identifying the location of confidential information to a respondent 106. However, the job processor server 204 first ensures that the confidential information is not decipherable by the respondent 106. The job processor server 204 uses summary analysis to achieve this goal.

To prevent the respondent 106 from deciphering the confidential data, the job processor server 204 summarizes the job data such that a respondent 106 can identify the general location of confidential data without deciphering the confidential data itself Once the general location is identified, the job processor server 204 can divide the job data into task data such that the identified location is split into various task data.

For example, the job processor server 204 may apply summary analysis to an image that includes a face, which is identified as confidential information. The summary of the image may comprise a thumbnail reduced to a size such that the location of the confidential object can be identified but not the confidential details of the objects. For example, the job processor server 204 or respondent 106 can identify the outline of a confidential face in the thumbnail but may not be able to identify any features on the face because the face image is too small in the thumbnail. Once the location of the face is identified in the thumbnail, the job processor server 204 can find the corresponding location in the actual image and divide the image into various task data such that the face cannot be identified in any individual task.

### Break Analysis

The job processor server 204 may also divide job data using break analysis. For break analysis, the job processor server 204 identifies natural breaks in job data and divides job data into task data based on the identified natural breaks. The job processor server 204 identifies natural breaks based on the type of job data the server 204 receives. For example, natural breaks in a handwritten document might be letters, words, short phrases, or sentences. On the other hand, if the job data is audio data, the natural breaks may be pauses or detected silence that last longer than a threshold. Based on these detected breaks, the job processor server 204 divides the job data into task data such that the task data begin and end at breaks. Additionally, like safe size analysis, the job processor server 204 may use different offsets to create different task data sets from the same job data and decrease the likelihood of erroneous results in processing the task data.

Data Distortion

As explained above, the job processor server 204 may use a number of techniques to shred or divide the job data into smaller task data chunks such that the individual chunks do not include enough information for a respondent 106 to discern confidential information. Additionally, or alternatively, the job processor server 204 may distort data to protect confidential information contained therein.

To distort data, the job processor server 204 applies a function to the job data such that the confidential information in the resulting job data is distorted and the resulting job data cannot easily be inverted to its original form without secure information, like a security key. The job processor server 204 stores the key in a secure storage to limit unauthorized access to the key. For example, the job processor server 204 may distort the face in an image such that the face is not recognizable. The respondent analyzing the distorted image can still identify the location or existence of a face in the image even if the respondent 106 cannot tell who the person is. Accordingly, such distortion beneficially enables a respondent 106 to process the distorted data without acquiring the confidential data in the job. The job processor server 204 may distort job data through various techniques, such as filtering, public matching, smart replacement, model distortion, and scrambling.

Filtering

Filtering includes applying a filter to a data to distort the data. For example, for an image, the job processor server 204 may apply a spatial filter that blurs the confidential information in the image or a color filter that distorts the color content of the confidential information. For audio data, the job processor server 204 may distort audio by applying an acoustic filter that changes the audio data's characteristics (like pitch, volume rate etc.) to disguise the speaker's identity or confidential audio data.

For textual data, the job processor server 204 may distort text by applying a filter that adds noise to the text, retains some of the text's meaning, and/or destroys most of the confidential information. A translator may be used as a filter that translates a sentence into and back out of a second language. For example, translating a sentence from English to Russian and then back to English distorts the wording and still retains enough core meaning that the text can still be processed or classified in some way. Because some sentences would be rendered useless when processed through such a filter, the job processor server 204 may reduce the probability of error by creating redundant task data. The job processor server 204, in one embodiment, passes the original data through several translators and delegates the output as task data to different respondents 106. The responses from various respondents can be collectively analyzed to filter out the outliers created by sentences that are distorted to an extent that they become useless. Another example of adding noise includes substituting words with synonyms or phrases.

For video data, video consists of a series of images with an audio track. Accordingly, the job processor server 204 distorts video using filtering techniques for image data and audio data discussed above. Additionally, the job processor server 204 leverages from multiple related images in the video. For example, an image can be distorted not only based on a single frame of video, but by averaging many frames, or by constructing a new image by taking the extreme pixel value of a range of images. Similarly, the audio in the video can be distorted based on one or multiple audio frames.

Public Matching

For public matching, the job processor server 204 identifies confidential data in job data and replaces confidential data with publically available data. For example, for an image or for video, the job processor server 204 may replace confidential face images with a public face image. For textual data, the job processor server 204 replaces confidential text with public text like generic names, location etc.

Smart Replacement

Smart replacement includes redacting confidential data in job data. For example, for an image, the job processor server 204 may cover the face with a particular opaque shape to hide the face. For textual data, the job processor server 204 redacts confidential words, phrases, or sentences from the text in job data. For audio data, the job processor server 204 uses audio processing techniques to determine confidential data like names, places etc. The job processor server 204 then redacts the identified confidential data. For video data, smart replacement techniques for images and audio may be applied. Additionally, the job processor server 204 may leverage from multiple related images in the video as discussed in context of filtering.

Scrambling

Scrambling includes moving data around such that the confidential data is lost in the moved data and a respondent 106 can still process the moved data. The job processor server 204 can scramble text included in images to hide the confidential information. For example, respondents 106 may be delegated to perform OCR on an image including confidential text. However, before transmitting the image to the respondent 106, the job processor server 204 scrambles the textual words in the image such that the confidential information loses its context, thus obscuring the confidential content of the text. Examples of an original sentence and scrambled sentence below illustrate how the job processor server 204 obscures the confidential information.
Original sentence: Tim and Tom are meeting at 6 pm in San Francisco. Laura is having dinner with Megan the next day at 9 pm in a restaurant in Mountain View.
Scrambled sentence: “Laura and Tim are meeting at 9 pm in San Francisco. Tom is having dinner with Megan the next day at 6 pm in Mountain View.”

In the example above, the confidential information about the time and place of the two meetings has been obscured because of scrambling. The respondent 106 may receive the scrambled sentence and perform tasks like OCR and spell check without learning the confidential information about the two meetings.

The scrambling example above is equally applicable to textual data. The job processor server 204 may scramble the textual data in the same manner as it scrambles the text in an image as described above.

For audio data, standing alone or in video, the job processor server 204 scrambles the audio in a manner described above for text in images. The job processor server 204 scrambles various words in the audio to form new sentences and transmits the new sentences to the respondent 106 for processing. In one embodiment, the job processor server 204 scrambles words from two or more audio files to further obscure the confidential information. Additionally, to reduce errors, the job processor server 204 creates multiple scrambles for the same job data and transmits different scrambles to different respondents 106. The respondents complete their task and provide responses to the job processor server 204. Based on the received responses, the job processor server 204 identifies the outliers as errors.

Model Distortion

For model distortion, the job processor server 204 matches the job data to a particular model, generates new data based on the matched model and transmits the generated data for processing by the respondent 106. For example, for an image, the job processor server 204 creates a generic face representing all the features in a human face. The job processor server 204 then identifies the faces in an image and replaces particular faces with the generic face. For images including handwritten notes, the job processor may apply model distortion for hiding the handwriting in the notes. The job processor server 204 identifies a vectorized model for handwritten notes and converts the handwritten notes into computer-generated strokes that retain the written content but hide the handwriting in the notes.

For text data, the job processor server 204 fits the text in the job data to a Hidden Markov Model or a Bag of Words model. In Bag of Words model, words are chosen at random to form a sentence according to the frequency of each word's occurrence in the data. In Hidden Markov Model, the word frequency is dependent on the choice of the previously chosen word. Therefore, a condition distribution is calculated for each word in the set (i.e. the frequency of words that occur after a given word). These condition distributions for various words are used to construct sentences by selecting a first word, and then a second word conditioned on the first word. The job processor server 204 generates new text based on a Hidden Markov Model or a Bag of Words model and transmits the generated text to respondent 106 for processing.

For audio data, the job processor server 204 identifies a model with a generic voice and converts the voices in the audio data to the generic voice. Such distortion hides the identity of speakers in audio data. To reduce errors created by a particular voice model, the job processer server 204 applies various generic voice models to audio data. The output of these models is individually processed and the outliers in the outputs are identified as errors. For video data, the job processor 204 applies the model distortion techniques for images and audio data discussed above. Additionally, the job processor server 204 leverages from multiple related images in the video as discussed above.

In sum, the job processor server 204 uses one or more of the above mentioned techniques to distort the job data such that a respondent 106 delegated to process all or part of the job data cannot discern the confidential information in the job data. Moreover, in addition to data shredding and data distortion, the job processor server 204 distributes job data in a manner that further protects the confidential information in job data.

### Data Distribution

Returning to FIG. 6A, after the job data is shredded and/or distorted 606, the job processor server 204 determines 608 the respondents for processing the task data resulting from the job data. The job processor server 204 chooses respondents 106 and distributes 610 task data to respondents 106 such that no single respondent 106 receives enough data to discern confidential information through brute-force. In one embodiment, the job processor server 204 only distributes a single task data chunk to any respondent 106. Accordingly, no respondent 106 receives more than one task data chunk and therefore the respondent 106 does not have adequate data to discern confidential information in job data. Moreover, the job processor server 204 chooses various respondents 106 to process the task data for a job such that it will take maximal effort to collect, identify, and reassemble the task data into job data.

The job processor server 204 may distribute the tasks in a number of ways. For example, the job processor server 204 distributes task data associated with the job data to respondents 106 who are geographically distant from each other. The job processor server 204 identifies the geographic location of a respondent 106 through registration information of the respondent 106, information from USSD (part of the GSM protocol of mobile phones) of a mobile phone associated with the respondent 106, an IP address associated with the respondent 106, a Wi-Fi MAC address associated with the respondent 106, GPS information associated with the respondent, or the known locations of cell towers associated with the respondent 106.

Additionally, the job processer server 204 may create temporal separation between different respondents 106 working on various tasks associated with a job. Accordingly, the job processor server 204 may delegate different respondents to work on different tasks associated with a job at different times. Moreover, the job processor server 204 may create content separation by mixing data from two or more jobs in a task. Accordingly, a respondent 106 working on a task may not even be able to determine the job associated with the task at hand. Also, the job processor server 106 may create social separation by distributing tasks for a job to various respondents 106 that are unlikely to socialize with each other. For example, the job processor server 204 may distribute tasks to respondents 106 of different age groups that normally do not socialize with each other.

Additionally, the job processor server 204 may encrypt task data for each respondent with a different key. In this embodiment, an intruder trying to intercept the transmission of task data would have to determine all the keys associated with the transmitted task data to decrypt all the job data. This use of different keys therefore makes the data more secure as the intruder is left with a cumbersome task of deciphering data encrypted with numerous keys.

Next, the tasks are sent 610 to the respondent devices and displayed 612 to the respondents. Upon completion of the task, a response is received 614 by the respondent device 206 from the respondent and the respondent device 206 transmits 616 the response to the server 204. The job processor server 204 then integrates the received responses to determine the response for the job as a whole.

### Response Integration/Reconstruction

When the job processor server 204 divides job data into various task data chunks, the job processor server 204 delegates a unique identifier to each task data chunk associated with the job. An example of a unique identifier is the time associated with delegation of a task combined with the identifier of the delegated respondent 106. After the respondent 106 processes the task data, the respondent device 206 transmits the respondent's response with the task data's unique identifier. The job processor server 204 receives the transmitted response and the unique identifier, and uses the received identifier to integrate the respondent's response into a unified response for the job.

In one embodiment, data shredding occurs on the same physical site where the job data was received. Accordingly, the job data does not leave the physical site as one integrated document. In another embodiment, the tasks' unique identifier need not be electronically transmitted to the respondent 106 and instead are tracked internally. For example, a respondent 106 may be given only one task at a time, and the respondent may not receive a new task until the respondent 106 provides the response for a previous task. Because the respondent 106 has only one task at any given time, the job processor server 204 can track the current task for the respondent 106 and associate a response to the task when the respondent 106 sends a response to the job processor server 204. In this embodiment, the job processor server 204 maintains an internal identifier for the task, and the server 204 does not transmit the identifier with task data to respondent 106. Alternatively, the task's unique identifier can be first sent to a secure server and the corresponding task data distributed later to respondent 106 from the secure server.

Regardless of how the job processor server 204 associates responses with a job, the job processor server 204 receives and combines the responses to determine a unified response for the job. In one embodiment, the job processor 204 had previously created and distributed different sets of task data using the same job data. Accordingly, the job processor server 204 receives different sets of responses that are combined to form different unified responses. In this embodiment, the job processor server 204 determines the best unified response based on the determined unified responses. For example, if three of the five unified responses indicate the same result, the job processor server 204 determines that the three unified responses represent the best result for the job's unified response.

In another embodiment, the job processor server 204 determines the likelihood of a unified response being correct based on the determined unified responses or received task responses. In this embodiment, the job processor server 204 may present various unified responses to the job provider client along with the probability of the response being correct. In another embodiment, the job processor server 204 uses the response with the best probability as a reduced set of data that requires further processing. For example, a law firm may provide job data that includes a large corpus of data, and the law firm wants documents related to a particular topic. The job processor server 204 distributes the documents in the corpus to respondents 106, receives response, and presents a unified response to the law firm. The response with the best likelihood of success includes a much smaller data corpus than the one provided with job data. Additionally, the response includes the likelihood that each document in the corpus is related to the desired topic. The law firm can now analyze the smaller data corpus to identify the desired documents.

Returning to FIG. 6A again, after the job processor server 204 determines a unified response for the job, steps 618-638 are performed as explained above, and the job results are displayed on the job provider client 638. In this manner, the job processor server 204 beneficially receives secure job data and divides the job data to obscure confidential information. Accordingly, the respondents 106 processing the task data process the secure data without being able to discern the secure information in the data. The job processor server 204 therefore enables a client to distribute secure tasks to unsecure respondents without worrying about security leaks.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, or it may comprise a general-purpose computing device selectively activated or reconfigured by a computer program stored in the computer. Furthermore, any computing systems referred to in the specification may include a single processor or may be architectures employing multiple processor designs for increased computing capability. Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes rather than to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for performing a job by a distributed group of people, the method comprising:
receiving job data associated with the job from a job provider, the job data including confidential information;
generating a plurality of chunks of task data from the job data, each of the chunks of task data including information that alone is inadequate to determine the confidential information of the job data;
dividing the job into a plurality of tasks, where at least one of the plurality of tasks is associated with a chunk of task data and comprises processing the associated chunk of task data;
delegating the tasks to a plurality of persons of the distributed group of people;
sending the delegated tasks over a network to electronic devices associated with the persons to whom the tasks are delegated;
receiving responses for the delegated tasks over the network from the electronic devices associated with the persons to whom the tasks are delegated;
determining a result based on the received responses; and
communicating the result to the job provider.

2. The method of claim 1, wherein modifying job data into a plurality of chunks of task data comprises:
determining a plurality of locations in the job data that include confidential information; and
dividing job data into the plurality of chunks of task data such that confidential information in one of the plurality of locations is divided amongst more than one chunk of task data.

3. The method of claim 1, wherein modifying job data into a plurality of chunks of task data comprises:
determining a plurality of locations in the job data that include confidential information; and
distorting information located in the determined plurality of locations in the job data.

4. The method of claim 3, wherein distorting information located in the determined plurality of locations comprises replacing the information located in the determined plurality of locations with publically available information.

5. The method of claim 3, wherein distorting information located in the determined plurality of locations comprises scrambling the located information such that at least parts of the scrambled information is moved from its original location in the job data.

6. The method of claim 1, further comprising:
receiving a second set of job data associated with a second job;
mixing data from the second set of job data with data from the job data; wherein modifying job data into a plurality of chunks of task data comprises including mixed data in at least one of the plurality of chunks of task data.

7. The method of claim 1, further comprising applying a spatial filter to blur the confidential information.

8. The method of claim 1, wherein the least one of the plurality of tasks further comprising a request for a response from one or more persons of the distributed group of people and a collection of responses for the tasks comprises a result for the job

9. A non-transitory computer readable storage medium storing executable computer program instructions for performing a job by a distributed group of people, the instructions comprising instructions for:
receiving job data associated with the job from a job provider, the job data including confidential information;
generating a plurality of chunks of task data from the job data, each of the chunks of task data including information that alone is inadequate to determine the confidential information of the job data;
dividing the job into a plurality of tasks, where at least one of the plurality of tasks is associated with a chunk of task data and comprises processing the associated chunk of task data;
delegating the tasks to a plurality of persons of the distributed group of people;
sending the delegated tasks over a network to electronic devices associated with the persons to whom the tasks are delegated;
receiving responses for the delegated tasks over the network from the electronic devices associated with the persons to whom the tasks are delegated;
determining a result based on the received responses; and
communicating the result to the job provider.

10. The computer readable storage medium of claim 9, wherein modifying job data into a plurality of chunks of task data comprises:
determining a plurality of locations in the job data that include confidential information; and
dividing job data into the plurality of chunks of task data such that confidential information in one of the plurality of locations is divided amongst more than one chunk of task data.

11. The computer readable storage medium of claim 9, wherein modifying job data into a plurality of chunks of task data comprises:
determining a plurality of locations in the job data that include confidential information; and
distorting information located in the determined plurality of locations in the job data.

12. The computer readable storage medium of claim 11, wherein distorting information located in the determined plurality of locations comprises replacing the information located in the determined plurality of locations with publically available information.

13. The computer readable storage medium of claim 11, wherein distorting information located in the determined plurality of locations comprises scrambling the located information such that at least parts of the scrambled information is moved from its original location in the job data.

14. The computer readable storage medium of claim 9, further comprising instructions for:
receiving a second set of job data associated with a second job;
mixing data from the second set of job data with data from the job data; wherein
modifying job data into a plurality of chunks of task data comprises including mixed data in at least one of the plurality of chunks of task data.

15. A computer system for performing a job by a distributed group of people, the computer system comprising:
a computer-readable medium storing executable program instructions comprising instructions for:
receiving job data associated with the job from a job provider, the job data including confidential information;
generating a plurality of chunks of task data from the job data, each of the chunks of task data including information that alone is inadequate to determine the confidential information of the job data;
dividing the job into a plurality of tasks, where at least one of the plurality of tasks is associated with a chunk of task data and comprises processing the associated chunk of task data;
delegating the tasks to a plurality of persons of the distributed group of people;
sending the delegated tasks over a network to electronic devices associated with the persons to whom the tasks are delegated;
receiving responses for the delegated tasks over the network from the electronic devices associated with the persons to whom the tasks are delegated;
determining a result based on the received responses; and
communicating the result to the job provider.

16. The computer system of claim 15, wherein modifying job data into a plurality of chunks of task data comprises:
determining a plurality of locations in the job data that include confidential information; and
dividing job data into the plurality of chunks of task data such that confidential information in one of the plurality of locations is divided amongst more than one chunk of task data.

17. The computer system of claim 15, wherein modifying job data into a plurality of chunks of task data comprises:
determining a plurality of locations in the job data that include confidential information; and
distorting information located in the determined plurality of locations in the job data.

18. The computer system of claim 17, wherein distorting information located in the determined plurality of locations comprises replacing the information located in the determined plurality of locations with publically available information.

19. The computer system of claim 17, wherein distorting information located in the determined plurality of locations comprises scrambling the located information such that at least parts of the scrambled information is moved from its original location in the job data.

20. The computer system of claim 15, further comprising instructions for:
receiving a second set of job data associated with a second job;
mixing data from the second set of job data with data from the job data; wherein
modifying job data into a plurality of chunks of task data comprises including mixed data in at least one of the plurality of chunks of task data.

21. The method of claim 1, further comprising:
receiving a response for a task from an electronic device of a person assigned to the task;
determining that the received response is acceptable; and
providing a reward for the received response to the assigned person.

22. The method of claim 1, wherein the job data includes a questionnaire associated with a product or a service, and each of the plurality of tasks includes gathering responses for a plurality of questions from the questionnaire.
